(19) United States
(12) Patent Application Publication
(10) Pub. No.: US 2014/0273982 A1
(43) Pub. Date: Sep. 18, 2014

(54) METHOD AND APPARATUS FOR PROCESSING OUTGOING CALL CONNECTION BASED ON ACTUAL LOCATION

(71) Applicants: Bryan Faliero, Charleston, SC (US); Jon Mazzoli, Charleston, SC (US); Michael Johnston, Suwanee, GA (US)

(72) Inventors: Bryan Faliero, Charleston, SC (US); Jon Mazzoli, Charleston, SC (US); Michael Johnston, Suwanee, GA (US)

(21) Appl. No.: 13/796,488

(22) Filed: Mar. 12, 2013

(51) Int. Cl. H04M 3/42

(52) U.S. Cl. CPC H04M 3/42348
USPC 455/414.1; 379/207.12

(57) ABSTRACT

A system and method for determining whether to connect an outgoing call are provided. A request is received to connect an outgoing call including a phone number of a device to receive the outgoing call. A location routing number (LRN) associated with the phone number is obtained, and an actual location is associated to the device based at least in part on the LRN. The actual location of the device is utilized in determining whether to connect the outgoing call. This can be in conjunction with evaluating one or more rules for connecting calls based on the actual location.

### BACKGROUND

Some entities are in the business of placing calls to consumers to obtain survey/marketing data, to sell products, to collect on past due accounts, to enlist consumers in mailing lists or sweepstakes, etc. Jurisdictional laws and/or regulations (e.g., federal, state, local, etc.) may place limits on certain calls from these entities to consumers, such as hours during which calls can be made, restricting calls to land lines only (e.g., no cell phone calls), quantity of calls over a given time period, etc. Such laws and/or regulations may be mandated based on actual physical location of the customer, and violation of the laws and/or regulations may provide cause for remediation. Entities in this line of business often use computer-based call routing that determines whether to connect calls based on a set of rules and databases. The rules and databases typically employed, however, rely on area codes and exchanges in a telephone number to determine location of a consumer to effectuate compliance with the restrictive regulations.

Due to certain trends in consumer use in telecommunications, relying on these rules and databases may not allow the entities to adequately comply with restrictive regulations when phoning consumers where the consumers are physically located in an area unrelated to their provided area code, exchange, zip code, etc. This can occur where a consumer moves to a new residence and retains their original phone number, where a consumer is traveling with a cellular phone, where a consumer has forwarded phone calls to an alternative number, and/or the like. In such instances, systems that do not account for actual physical location of a consumer may allow an entity to connect a call to a consumer in violation of the restrictive laws and/or regulations where the consumer resides or is otherwise situated at that time.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to processing outgoing calls based at least in part on a location routing number (LRN) related to the outgoing calls. For example, a LRN database can map LRNs to various information, such as a phone number to which a LRN is associated, information for identifying an actual physical location or at least a region associated with the LRN, and/or the like. Thus, a LRN can be obtained for an outgoing call, and location information for the outgoing call is determined based on the LRN. In this regard, call centers that place calls to consumers subject to certain laws and/or regulations can use the LRN database in association with a set of defined rules to provide compliance with the laws and/or regulations when connecting outgoing calls. The LRN database can be populated from one or more sources, such as one or more carriers operating over public switch telephone networks, voice-over-internet protocol providers, cellular network providers, and/or the like. For example, such providers can populate the LRN database based on one or more timers or events to ensure the LRN database stores recent location information of their subscribers.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIG. 1 is an aspect of an example system for utilizing a location routing number (LRN) database to route calls.

FIG. 2 is an aspect of an example system for determining whether to connect calls based on LRN or related location information.

FIG. 3 illustrates example LRN database schemas.

FIG. 4 is an aspect of an example methodology for determining whether to connect a call based at least on LRN.

FIG. 5 is an aspect of an example methodology for determining whether to connect a call based on analyzing rules based on location information determined from a LRN.

FIG. 6 is an aspect of an example system in accordance with aspects described herein.

FIG. 7 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to utilizing a location routing number (LRN) to determine a location of a device for routing an outgoing call thereto. A LRN database, for example, can store a list of phone numbers and corresponding LRNs. Thus, upon initiation of an outgoing call, the LRN database is queried to determine a LRN associated with the phone number, and the call is routed using the LRN. The LRN can also be used, as described herein, to identify a coarse or fine location associated with the device. For example, the LRN correlates to an identifier of a switching port of a local telephone exchange for routing a call thereto. LRNs can be managed by a Number Portability Administration Center (such as the Center operated by Lockheed Martin in the United States under appointment of the Federal Communications Commission). Using LRN, when a phone number is dialed, the local telephone exchange queries a LRN database (e.g., a service control point (SCP), etc.) for the LRN associated with the subscriber. The LRN removes the need for the public telephone number to identify the local exchange carrier, as in current NPA-NXX format numbers in North American Telephone Numbering Systems. Moreover, using LRN allows for retaining a current telephone number even if a subscriber changes to another telephone service provider (e.g., in another city, state, or otherwise); in such cases, only the LRN associated with the telephone number is changed. In this regard, at least the telephone switch can be identified from the LRN, and a location of the telephone switch can be an assumed location of a phone line to which an outgoing call is made for the purposes of determining whether to connect the call based on one or more rules specific to the location.

For example, a phone number may have an area code associated with a west coast location, but can be mapped (in the LRN database/SCP) to a LRN that routes to an east coast phone line (e.g., where the consumer associated with the phone number moves). Thus, the LRN can be used to determine the actual location of the consumer's phone line, and rules can be applied based on that location instead of the area code location, billing address, or other proxy for the physical location. Call centers can use such logic to promote more appropriate compliance with laws and regulations regarding contacting consumers. For example, where call centers are prohibited from calling consumers after a certain time in the evening, the location information inferred from the LRN can be used to determine a coarse location of the consumers' phone lines and thus corresponding time zones to ensure the consumers are not contacted after the certain time in their respective time zones.

In one example, the LRN database can be populated by various sources using various mechanisms to store relatively current LRN to phone number mappings. The LRN database can be, or can include, one or more third party databases managed by one or more telephone companies or government agencies. Thus, in one example, the LRN database can be populated by carriers that utilize a public switch telephone network (PSTN), such as a local exchange carrier (LEC), competitive LEC (CLEC), regional bell operating carrier (RBOC), and/or the like to include LRNs of a plurality of subscribers. Thus, the LRN database can be, or can include, a service control point (SCP) database or other routing database used by one or more carriers. Moreover, in an example, a voice-over-internet protocol (VoIP) provider, cellular network, etc. can additionally or alternative populate the LRN database with subscriber information or other information to facilitate receiving subscriber information for a given LRN. In yet another example, the LRN database can be configured by one or more entities to pull, or otherwise receive, data from such routing databases or the related providers in a centralized location. In another example, additional information can be added to a currently existing LRN database, such as more accurate location information (e.g., global positioning system (GPS) coordinates for the phone, consumer address, zip code, time zone, etc.).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for employing a LRN database to determine whether to route one or more outgoing calls. System 100 can include a LRN database 102 and a call originator 104 that queries the LRN database 102 as part of determining whether to connect outgoing calls. System 100 can also optionally include a PSTN 106, VoIP provider, 108, and/or cellular network 110 that can populate the LRN database 102, in one or more examples. Cellular network 110 can include one or more base stations 112 serving one or more devices to which an outgoing call can be connected.

According to an example, the LRN database 102 can be substantially any database that maps one or more LRNs to one or more related phone numbers. Thus, call originator 104 can obtain a LRN for a phone number of an outgoing call via the LRN database 102, and can use location information corresponding to the LRN in determining whether to connect the outgoing call. In one example, obtaining the LRN can occur as part of the call processing where the call originator 104 uses the LRN to determine a switching port for a local telephone exchange from a SCP for routing the call. In any case, the LRN can specify one or more telephone network components (e.g., a telephone switch), and a location of the telephone network components can be associated as a coarse location of a recipient device of the outgoing call from call originator 104 for the purposes of determining whether to connect the call.

In an example, the LRN database 102 can be utilized by one or more PSTNs 106 or related carriers, VoIP providers 108, and/or cellular networks 110 to connect outgoing calls by determining LRNs associated with called phone numbers, as described. In addition, carriers that utilize PSTNs 106, VoIP providers 108, and/or cellular networks 110 can populate the LRN database 102 with phone numbers and LRNs related to their respective subscriber phone lines. For example, a carrier using the PSTN 106 can provide a listing of LRNs and related phone numbers to which the PSTN 106 can route calls. Thus, call originator 104 can determine LRNs related to phone numbers for outgoing calls to the PSTN 106 by querying the LRN database 102. The call originator 104 can then determine a location of a network switch indicated by the LRN in determining whether to connect the outgoing call.

In another example, a VoIP provider 108 and/or cellular network 110 can provide a list of LRNs and associated phone numbers of their subscribers to the LRN database 102. In this example, however, the LRNs can correspond to network switches or other telephone network components of the VoIP provider 108 and/or cellular network 110 that are located relatively remotely from the corresponding subscribers, as the components can be a mere entry point into the VoIP or cellular network. In this regard, upon encountering a LRN for an outgoing call that corresponds to a network switch or other component to access a VoIP network or a mobile switching center (MSC) of a cellular network, the call originator 104 can attempt to obtain location information from one or more other sources. For example, the call originator 104 can identify the specific VoIP or cellular network from the LRN and can accordingly query one or more components of the specific network to determine location information stored for the subscriber identified by the phone number of the outgoing call.

In yet another example, the LRN database 102 can include additional information, such as location information for associated stored LRNs or phone numbers. In this example, the LRN database 102 can be populated with not only a LRN and related phone numbers for the carrier using the PSTN 106, but also a current subscriber address, zip code, time zone, and/or the like. In addition, in this example, VoIP provider 108 and/or cellular network 110 can accordingly include location information for specific devices corresponding to the telephone numbers in the LRN database 102, such as GPS coordinates for the devices or corresponding base stations 112 to which the devices are connected, zip codes, time zones, etc. The LRN database 102 can additionally or alternatively allow storage of a universal resource location (URL), network address, or other identifier for requesting specific location information for device corresponding to the telephone numbers in the LRN database 102. Thus, upon encountering a LRN entry in the LRN database 102 specifying such a URL, network address, or other identifier, the call originator 104 can further contact one or more components based on the URL, network address, or other identifier and specify the phone number to obtain location information. Moreover, in these examples, where location information is specified in the LRN database 102 or otherwise obtained by call originator 104 from VoIP provider 108, cellular network 110, etc., the location information can be of substantially any granularity (e.g., GPS coordinates, address, zip code, time zone, etc.).

In any case, the call originator 104 uses the location information inferred from a LRN or otherwise received from the LRN database 102 or other source for processing outgoing calls. For example, the call originator 104 may receive a request to process an outgoing call to phone number having an area code related to the east coast of the United States. The call originator 104 can query the LRN database 102 to determine a LRN associated with the phone number. In this example, associated location information can be inferred from the LRN, such as a telephone switch located in a city on the west coast of the United States. Thus, not only can the call originator 104 process rules based on a time zone of the west coast city where the telephone switch (and thus the actual phone) is located, but the call originator 104 can also employ rules local to the city, state, or other defined area encompassing the west coast city in determining whether to connect the call, as opposed to rules related to the east coast area code of the phone number. Where the rules are properly configured, this can result in compliance with laws and regulations of where the phone (and thus the called party) is actually located at the time of the call.

In any case, the LRN database 102 can be populated and updated with relatively current LRN information (and/or location information). This can occur in real-time (e.g., based on detecting additions, modification, deletions, etc. by a carrier using the PSTN 106, VoIP provider 108, cellular network 110, etc.). In another example, the LRN database 102 can be populated by periodically pulling data from one or more of these sources. Moreover, as described above, in one example, it is to be appreciated that the LRN database 102 can include one or more distributed databases proprietary to the network populating the database, and call originator 104 can determine the appropriate proprietary database to query based on the phone number. In another example, a centralized component (not shown) can query the various proprietary databases and populate the LRN database 102 with LRN/phone number mappings (and/or location information, URLs for determining location information, etc.) for use by call originator 104 or other call processing systems.

FIG. 2 illustrates an example system 200 for processing outgoing calls at a call originator. System 200 includes a LRN database 102 and call originator 104, as described above, where the LRN database 102 can be populated by one or more of a carrier using a PSTN, a VoIP provider, a cellular network, etc., to include LRNs associated with phone numbers (and/or related location information). System 200 also includes a call network 202 to connect outgoing calls from the call originator 104. For example, call network 202 can include one or more components of a telephone network (e.g., a PSTN, VoIP network, cellular network, private business exchange (PBX), etc.) to connect outgoing calls from the call originator 104 to an associated line.

Call originator 104 can include one or more components that provide logic for routing calls from auto-dialer 208 or handset 210 to a third-party. These component(s) can be resident in a call center, as described previously, or other location (e.g., a remote agent) such that outgoing calls are forwarded through the component(s) (e.g., to allow for applying one or more rules thereto). Call originator 104 can include, among other components, a carrier component 204 to determine whether to route one or more outgoing calls based on information regarding the calls, a call routing component 206 to connect the calls upon determining to route the calls by carrier component 204, and an optional auto-dialer 208 or handset 210 to originate the outgoing calls in the call originator 104. In one example, the auto-dialer 208 can be a predictive dialer that connects answered calls to agents of the call originator 104. Carrier component 204 can include a call request component 212 for receiving a request to connect an outgoing call, a location determining component 214 for obtaining location information related to the outgoing call, and a call connecting component 216 for determining whether to connect the outgoing call based at least in part on the location information. Call connecting component 216 can also include a rules engine 218 for applying a set of location-specific rules to the outgoing call for determining whether to connect the outgoing call, and the rules engine 218 can include a rules database 220 for storing the various rules.

According to an example, auto-dialer 208 and/or handset 210 can initiate an outgoing call in call originator 104. As described, call originator 104 can be subject to certain laws and regulations when placing outgoing calls, such as a permissible time period during which outgoing calls can be placed. In this regard, carrier component 204 receives requests to connect outgoing calls from auto-dialer 208 and/or handset 210. The requests can include at least an outgoing phone number, from which carrier component 204 can determine additional information. Call request component 212 can obtain the request from auto-dialer 208 and/or handset 210. Call request component 212 can determine the phone number related to the outgoing call and can provide the phone number to the location determining component 214.

In this example, location determining component 214 can obtain a LRN related to the phone number by querying LRN database 102. Location determining component 214 can then infer a location of a phone line or receiving device (and thus a related consumer) for the phone number based on the LRN. As described, the LRN can identify a telephone switch (e.g., as a portion of the numbers in the LRN), and location determining component 214 can associate a location of the telephone switch as an actual location of the device related to the phone number. For example, location determining component 214 can access a database or other repository including location of various telephone switches in a geographical area to obtain the location of the telephone switch corresponding to the LRN. The location determining component 214 can associate the location of the telephone switch with the outgoing call, and can provide the information to call connecting component 216 for determining whether to connect the call based on one or more additional rules and in consideration of the associated location.

The one or more rules can be retrieved from rules database 220 based on the location and can be applied with additional information to determine whether call connecting component 216 should connect the outgoing call. For example, the rules engine 218 can apply rules specific to the location, such as rules compliant with laws and regulation in a state or other geographical area comprising the location. Additionally, the rules engine 218 can apply rules based on a time zone comprising the location. Where rules engine 218 determines that connecting the outgoing call is compliant with rules in rules database 220, call connecting component 216 can utilize call routing component 206 to connect the outgoing call to the auto-dialer 208 and/or handset 210 via call network 202. Where rules engine 218 determines connecting the call is in violation of one or more rules in rules database 220, call connecting component 216 can refrain from engaging call routing component 206 and/or can indicate termination of the outgoing call to auto-dialer 208 and/or handset 210. In this regard, even calls initiated by an employee using the handset 210 at their discretion can be blocked based on laws and regulations of where the called phone (and thus the called party) is actually located (and/or other rules configured at the call originator 104) to promote compliance therewith.

In a specific example, auto-dialer 208 can attempt an outgoing call to a phone number having an area code corresponding to a city in the Pacific Standard Time time zone. Auto-dialer 208 can request the outgoing call to carrier component 204, and call request component 212 receives the request. Call request component 212 can utilize location determining component 214 to obtain a LRN for the outgoing call from the LRN database 102 (e.g., based on the phone number), and to infer a location for the outgoing call by identifying a telephone switch from the LRN. In this example, the location of the telephone switch of the LRN may be a city in the Eastern Standard Time time zone. Location determining component 214 can provide the telephone switch location along with outgoing call information to the call connecting component 216. In addition or in the alternative, location determining component 214 can provide other obtained or determined location information to the call connecting component 216 as well, such as a time zone associated with the telephone switch location, or the call connecting component 216 can otherwise determine such.

In this example, call connecting component 216 can utilize the received location information to determine whether to connect the outgoing call based on one or more rules used by rules engine 218. For example, rules database 220 may include a rule to block outgoing calls at 8:00 pm local time across the United States. Rules engine 218 can determine a local time in the time zone associated with the telephone switch location. Thus, in this example, if the local time in the Eastern Standard Time time zone is later than 8:00 pm (regardless of the time in the Pacific Standard Time time zone related to the phone number area code), rules engine 218 can indicate to call connecting component 216 to block the outgoing call. Thus, call connecting component 216 can refrain from forwarding the outgoing call to call routing component 206, and/or can indicate to auto-dialer 208 that the call was not completed. The call connecting component 216 can also indicate a reason for not completing the call. Moreover, in this regard, rules database 220 can also include location specific rules that can be applied based on the telephone switch location (e.g., a rule to block calls to consumers in California after 8:00 pm local time, and a different rule to block calls to consumers in Nevada after 8:30 pm local time).

In other examples, LRN database 102 can store additional information, such as more specific location information for the phone numbers (e.g., a current subscriber address, zip code, time zone, GPS coordinates of a device to which a call terminates, etc.) and/or information regarding a source from which to obtain such location information. Where the LRN database 102 includes location information for a specific phone number, location determining component 214 can utilize this location information to indicate a location to call connecting component 216 for determining whether to connect the call. For instance, the LRN database 102 can include location information for phone numbers of devices in a cellular network where the location information correlates to a location of a base station to which the devices are connected. This can be a coarse location of the devices allowing for compliance of location specific calling rules. In other examples, devices in cellular networks (and/or VoIP networks) can have associated determined locations obtained by at least one of triangulating location of the devices based on network signals of one or more access points, receiving GPS coordinates specified by the devices, and/or the like. This location information can be fed to the LRN database 102 by the cellular network and/or VoIP provider, as described, and used in determining whether to connect outgoing calls to the devices.

Where the LRN database 102, in addition or alternatively, includes information of a source from which to obtain location information (e.g., a network address of a MSC 222, a VoIP gateway, a PBX relay, etc.), location determining component 214 can contact the source, such as the MSC 222, specifying the phone number to obtain location information of the related device. The obtained location information can be similar to those previously described and of substantially any granularity of location, such as GPS coordinates of the device, a triangulated location of the device, a location of a base station to which the device is connected, etc. Location determining component 214 can utilize this location information to indicate a location to call connecting component 216 for determining whether to connect the call.

FIG. 3 illustrates example database schemas 300, 302, 304, and 306 for the LRN database 102. As described, the LRN database 102 can have a schema at least partially similar to database schema 300 that associates phone numbers 310 to corresponding LRNs 312. A LRN database using such a schema 300 can be currently used by carriers (e.g., LEC, CLEC, RBOC, etc.), VoIP providers, and/or cellular networks to determine routing information for outgoing calls. Thus, an existing database having schema 300 can be utilized as described herein by determining a LRN associated with a phone number of an outgoing call and inferring location information (e.g., of the telephone switch) from the LRN.

In addition, however, the LRN database 102 can be modified, or a new database can be created, to have a schema at least partially similar to schema 302, 304 and/or 306, with explicit location information that can be used in determining whether to connect an outgoing call. As described, in one example, the LRN database 102 can be populated with data from proprietary databases (which may have similar schemas) and/or from an existing LRN database (which may have a schema similar to schema 300), etc. In any case, schema 302 includes a LRN 314 and associated SCP/location information 316, which is a current subscriber address in this example. Thus, for example, a carrier may generate a subscriber database having such information, and LRN database 102 with schema 302 can be populated with this information.

In another example, a cellular network and/or VoIP provider may have a subscriber database with location information for various subscribers, such as GPS coordinates or other location information of a base station serving subscriber devices, a reported GPS position of the devices, etc. Thus, LRN database 102 can have a schema at least partially similar to schema 304 with mobile phone numbers 318 and associated location information 320, such as GPS coordinates of a base station serving a device with the corresponding phone number.

Moreover, in another example, the LRN database 102 can have a schema similar to schema 306 specifying LRNs 322 and associated location information 324 in the form of a MSC (or other switching component) URL from which to obtain location information. Thus, a call originator, upon obtaining a MSC URL in the location information 324, can contact the MSC to obtain location information associated with a certain phone number, as described. It is to be appreciated that substantially any database schema that allows for obtaining location information related to a phone number can be utilized in this regard. The depicted schemas 300, 302, 304, and 306 are illustrative examples.

Referring to FIGS. 4 and 5, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for determining whether to connect an outgoing call. At 402, a request to connect an outgoing call can be received including a phone number of a device to receive the call. For example, the request can be received from an auto-dialer, a handset, and/or the like. Moreover, the call request can be received at a call originator for an entity that is subject to jurisdictional laws and/or regulations regarding connecting outgoing calls.

At 404, a LRN associated with the phone number can be obtained. For instance, the LRN can be obtained from a LRN database based on the phone number. The LRN can correspond to a termination point for outgoing calls to the phone number, and can include information regarding routing the call. Thus, for example, a telephone switch or other telephone network component can be identified in the LRN. In another example, the LRN can correspond to a MSC or other entry point into a VoIP, cellular, or similar telephone network.

An actual location can be associated to the device based at least in part on the LRN at 406. For example, this can be the location of the telephone switch or other component identified in the LRN. Thus, a location based on physical telephone network components can be associated to the device as opposed to a location based on an area code or other aspects of the phone number for the device. In another example, the associated actual location can be obtained from the telephone network component identified in the LRN (or in the LRN database).

At 408, it can be determined whether to connect the outgoing call to the device based at least in part on the actual location. For example, one or more rules can be analyzed to determine compliance therewith based at least in part on the actual location. For instance, where the rules relate to time, a time zone associated with the actual location can be used, as opposed to a time zone related to an area code of the phone number. Moreover, in an example, the one or more rules can be determined as a subset of rules in a rules database based at least in part on the actual location of the device (e.g., rules specific to a certain area may not need to be analyzed where the actual location is not in the certain area).

FIG. 5 illustrates an example methodology 500 for determining whether to connect an outgoing call. At 502, a LRN associated with an outgoing call can be determined. For example, the LRN can be obtained from a LRN database based on a phone number of the outgoing call. At 504, a location of the device related to the outgoing call can be obtained based on the LRN. This can include associating a location of a telephone switch identified in the LRN as the location of the device. In another example, location information can be determined from a network component correlated with the LRN or on location information for the LRN or phone number specified in the LRN database, as described in various examples above.

Optionally, at 506, calling rules can be determined based on the location of the device. For example, a rules database can include a plurality of different rules for determining whether to connect a call, and the rules can be location specific; thus, a subset of the rules is determined at 506 based on the actual location. At 508, calling rules are analyzed based on the location of the device. For example, where the rules allow for geographical interpretation of a parameter (e.g., time in a local time zone of the location), the rules can be so analyzed at 508 in view of the location. At 510, it can be determined whether connecting the call violates any one of or certain ones of the rules. If not, the call is connected at 512. If so, the call is blocked at 514. Blocking the call at 514 can also include reporting the blocking to a device initiating the outgoing call and/or can include a reason for the blocking (e.g., a rule that would otherwise be violated by connecting the call).

To provide a context for the various aspects of the disclosed subject matter, FIGS. 6 and 7 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 6, an exemplary environment 600 for implementing various aspects disclosed herein includes a computer 612 (e.g., desktop, laptop, server, hand held, programmable consumer or industrial electronics . . . ). The computer 612 includes a processing unit 614, a system memory 616 and a system bus 618. The system bus 618 couples system components including, but not limited to, the system memory 616 to the processing unit 614. The processing unit 614 can be any of various available microprocessors. It is to be appreciated that dual microprocessors, multi-core and other multiprocessor architectures can be employed as the processing unit 614.

The system memory 616 includes volatile and nonvolatile memory. The basic input/output system (BIOS), containing the basic routines to transfer information between elements within the computer 612, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 612 also includes removable/non-removable, volatile/non-volatile computer storage media. FIG. 6 illustrates, for example, mass storage 624. Mass storage 624 includes, but is not limited to, devices like a magnetic or optical disk drive, floppy disk drive, flash memory or memory stick. In addition, mass storage 624 can include storage media separately or in combination with other storage media.

FIG. 6 provides software application(s) 628 that act as an intermediary between users and/or other computers and the basic computer resources described in suitable operating environment 600. Such software application(s) 628 include one or both of system and application software. System software can include an operating system, which can be stored on mass storage 624, that acts to control and allocate resources of the computer system 612. Application software takes advantage of the management of resources by system software through program modules and data stored on either or both of system memory 616 and mass storage 624.

The computer 612 also includes one or more interface components 626 that are communicatively coupled to the bus 618 and facilitate interaction with the computer 612. By way of example, the interface component 626 can be a port (e.g., serial, parallel, PCMCIA, USB, FireWire . . . ) or an interface card (e.g., sound, video, network . . . ) or the like. The interface component 626 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 612 to output device(s) via interface component 626. Output devices can include displays (e.g., cathode ray tube (CRT), liquid crystal display (LCD), light emitting diode (LCD), plasma . . . ), speakers, printers and other computers, among other things.

According to an example, computer 612 can perform the call processing functions of the call originator, as described. In this example, the processing unit(s) 614 can comprise or receive instructions related to receiving outgoing call requests, determining LRNs, associating locations to potential outgoing call recipients, determining whether to connect a call based on the locations, etc., and/or other aspects described herein. It is to be appreciated that the system memory 616 can additionally or alternatively house such instructions and the processing unit(s) 614 can be utilized to process the instructions. Moreover, mass storage 624 can store LRNs, device location information, etc., as described.

FIG. 7 is a schematic block diagram of a sample-computing environment 700 with which the subject innovation can interact. The environment 700 includes one or more client(s) 710. The client(s) 710 can be hardware and/or software (e.g., threads, processes, computing devices). The environment 700 also includes one or more server(s) 730. Thus, environment 700 can correspond to a two-tier client server model or a multi-tier model (e.g., client, middle tier server, data server), amongst other models. The server(s) 730 can also be hardware and/or software (e.g., threads, processes, computing devices). The servers 730 can house threads to perform transformations by employing the aspects of the subject innovation, for example. One possible communication between a client 710 and a server 730 may be in the form of a data packet transmitted between two or more computer processes.

The environment 700 includes a communication framework 750 that can be employed to facilitate communications between the client(s) 710 and the server(s) 730. Here, the client(s) 710 can correspond to program application components and the server(s) 730 can provide the functionality of the interface and optionally the storage system, as previously described. The client(s) 710 are operatively connected to one or more client data store(s) 760 that can be employed to store information local to the client(s) 710. Similarly, the server(s) 730 are operatively connected to one or more server data store(s) 740 that can be employed to store information local to the servers 730.

By way of example, one or more clients 710 can be call originators or components thereof, requesting LRNs and/or related location information for phone numbers from server(s) 730, which can include a server that communicates with a LRN database/SCP (e.g., server data store(s) 740), via communication framework 750. The server(s) 730 can, in one example, determine a LRN and/or related location information, and can transmit such back to the client(s) 710 via communication framework 750.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A method for determining whether to connect an outgoing call, comprising:
receiving a request to connect an outgoing call comprising a phone number of a device to receive the outgoing call;
obtaining a location routing number (LRN) associated with the phone number;
associating an actual location to the device based at least in part on the LRN; and
determining whether to connect the outgoing call to the device based at least in part on the actual location of the device.

2. The method of claim 1, wherein the associating comprises associating a location of a telephone switch indicated in the LRN as the actual location of the device.

3. The method of claim 1, wherein the associating comprises determining the actual location of the device based at least in part on querying a LRN database for location information associated with the LRN.

4. The method of claim 3, wherein the obtaining comprises obtaining the LRN from the LRN database based at least in part on the phone number.

5. The method of claim 3, wherein the location information comprises a location of a base station to which the device is connected.

6. The method of claim 1, wherein the determining comprises analyzing one or more rules specified in a rules database in view of the actual location of the device.

7. The method of claim 6, wherein the one or more rules specify a time period during which calls are permissible for a geographic area, and the analyzing comprises determining whether the a current time, as adjusted to a time zone of the actual location of the device, is within the time period.

8. The method of claim 7, wherein the determining comprises determining to block the outgoing call where the current time, as adjusted to the time zone of the actual location of the device, is not within the time period specified in the one or more rules.

9. The method of claim 6, wherein the one or more rules are defined in compliance with state or local laws or regulations regarding initiating outgoing calls for sales or marketing purposes.

10. The method of claim 9, further comprising determining the one or more rules as a subset of rules specified in a rules database based at least in part on the actual location of the device.

11. The method of claim 1, further comprising querying a telephone network component for the actual location of the device based at least in part on determining that the LRN corresponds to the telephone network component.

12. The method of claim 11, wherein the determining the LRN corresponds to the telephone network component is based at least in part on receiving an identifier of the telephone network component as associated with the LRN from a LRN database.

13. A system for determining whether to connect an outgoing call, comprising:
a call request component for receiving a request to connect an outgoing call comprising a phone number of a device to receive the outgoing call;
a location determining component for associating an actual location to the device based at least in part on a location routing number (LRN) obtained for the phone number; and
a call connecting component for determining whether to connect the outgoing call to the device based at least in part on the actual location of the device.

14. The system of claim 13, wherein the location determining component associates a location of a telephone switch indicated in the LRN as the actual location of the device.

15. The system of claim 13, wherein the location determining component associates the actual location of the device based at least in part on querying a LRN database for location information associated with the LRN.

16. The system of claim 15 wherein the location determining component obtains the LRN from the LRN database based at least in part on the phone number.

17. The system of claim 13, wherein the call connecting component analyzes one or more rules specified in a rules database in view of the actual location of the device.

18. The system of claim 17, wherein the one or more rules specify a time period during which calls are permissible for a geographic area, and the call connecting component determines whether the a current time, as adjusted to a time zone of the actual location of the device, is within the time period.

19. The system of claim 13, wherein the location determining component queries a telephone network component for the actual location of the device based at least in part on determining that the LRN corresponds to the telephone network component.
